(19) United States
(12) Patent Application Publication
(10) Pub. No.: US 2026/0038711 A1
(43) Pub. Date: Feb. 5, 2026

(54) CONDUCTIVE MEMBER

(71) Applicant: Yazaki Corporation, Tokyo (JP)

(72) Inventor: Shinichi YANAGIHARA, Shizuoka (JP)

(73) Assignee: Yazaki Corporation, Tokyo (JP)

(21) Appl. No.: 19/284,125

(22) Filed: Jul. 29, 2025

(30) Foreign Application Priority Data
Aug. 5, 2024 (JP) 2024-128885

(51) Int. Cl. H01B 7/08; H01B 7/02; H01B 7/29; H01B 17/58

(52) U.S. Cl. CPC H01B 7/08; H01B 7/02; H01B 7/292; H01B 17/58

(57) ABSTRACT

A conductive member includes a strip-shaped flat conductor, a resin tube installed to cover a periphery of the flat conductor, and a locking protrusion integrally formed on a surface of the flat conductor and configured to catch an inner peripheral surface of the installed resin tube.

### CROSS-REFERENCE TO RELATED APPLICATIONS

This application is based on and claims priority under 35 USC 119 from Japanese Patent Application No. 2024-128885 filed on Aug. 5, 2024, the entire content of which is incorporated herein by reference.

### TECHNICAL FIELD

The present disclosure relates to a conductive member.

### BACKGROUND ART

In the related art, a conductive member that is connected to a power supply such as a battery and supplies electricity to an electrical component or the like has been used in a power supply circuit or the like. Such a type of conductive member may include a strip-shaped flat conductor having a prescribed width.

The conductive member needs to ensure electrical insulation of the flat conductor. For example, there is known a technique of covering a flat conductor with an insulation material and a technique of insulating a flat conductor with a protector made of an insulation resin as disclosed in JP2014-107201A, JP2016-081731A, and JP2023-171187A.

When insulating a busbar (flat conductor) with, for example, insulation paper or an insulation tape, an operator needs to wear or wind the insulation paper or the insulation tape, and thus there is a problem that manufacturing of a conductive member is complicated and manufacturing costs increase.

When the busbar is insulated by resin molding, there is a problem that insert molding requires mold costs and manufacturing costs of a conductive member increase.

Further, when a periphery of the busbar is coated with an insulation material, equipment used for coating has a large size, and thus there is a problem that initial equipment costs and manufacturing costs of a conductive member increase.

Therefore, as illustrated in FIG. 6, there is a conductive member 501 as a conductive member having relatively low manufacturing costs, in which a strip-shaped busbar (flat conductor) 510 is inserted into a heat shrinkable resin tube (heat shrinkable tube), and the heat shrinkable tube is heated and heat-shrunk to form an insulation film 520 covering a part of an outer periphery of the busbar 510. The busbar 510 is made of a conductive metal plate having a substantially rectangular cross section, and has a connection hole 514 formed in each of two end portions in a longitudinal direction exposed from the insulation film 520.

However, the conductive member 501 does not have a positioning structure for the heat shrinkable tube that forms the insulation film 520, and when the heat shrinkable tube is displaced in a direction of an arrow X along the longitudinal direction as illustrated in FIG. 7, there is a possibility of insufficient insulation from other components and an electric shock due to touch.

The present disclosure provides a conductive member that can prevent positional deviation of a resin tube relative to a flat conductor.

### SUMMARY OF INVENTION

A conductive member includes a strip-shaped flat conductor, a resin tube installed to cover a periphery of the flat conductor, and a locking protrusion integrally formed on a surface of the flat conductor and configured to catch an inner peripheral surface of the installed resin tube.

According to the conductive member of the present disclosure, positional deviation of a resin tube relative to a flat conductor can be prevented.

The present disclosure has been briefly described above. Details of the present disclosure will be clarified by reading a mode (hereinafter, referred to as “embodiment”) for carrying out the present disclosure to be described below with reference to the attached drawings.

### BRIEF DESCRIPTION OF DRAWINGS

FIG. 1 is a perspective view of a resin tube of a conductive member according to an embodiment of the present disclosure illustrated in an imaginary line;

FIG. 2 is an overall perspective view of a flat conductor illustrated in FIG. 1;

FIG. 3 is an enlarged view of a portion A in FIG. 2;

FIG. 4 is a cross-sectional view taken along a line IV-IV in FIG. 1;

FIG. 5 is a perspective view illustrating a part of a resin tube of a conductive member according to a modification illustrated in an imaginary line;

FIG. 6 is a perspective view of a part of a conductive member in the related art; and

FIG. 7 is a perspective view illustrating a state in which the resin tube illustrated in FIG. 6 is displaced.

### DESCRIPTION OF EMBODIMENTS

Hereinafter, an embodiment of the present disclosure will be described with reference to the drawings.

A conductive member 1 according to the present embodiment is, for example, an inter-stack routing module used for electrical connection between a plurality of battery stacks. It is needless to say that the conductive member 1 of the present disclosure can be applied not only to the inter-stack routing module according to the present embodiment but also to various power supply circuits such as a high-voltage cable that electrically connects a battery assembly and a control device such as an inverter.

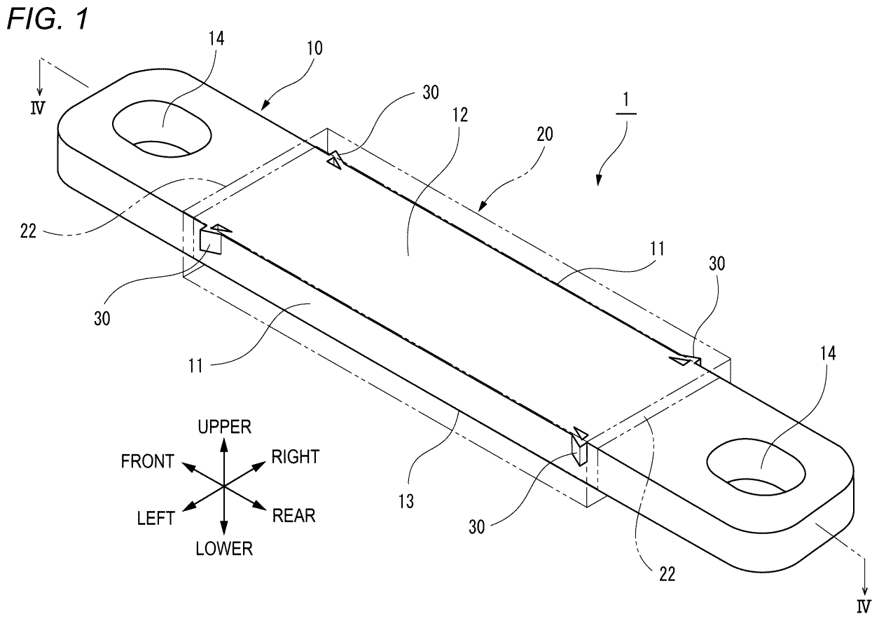

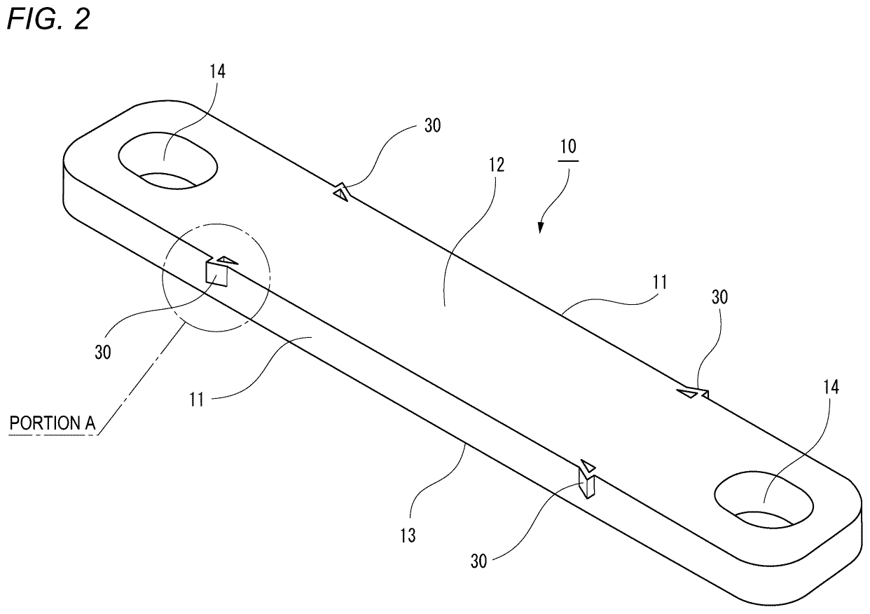

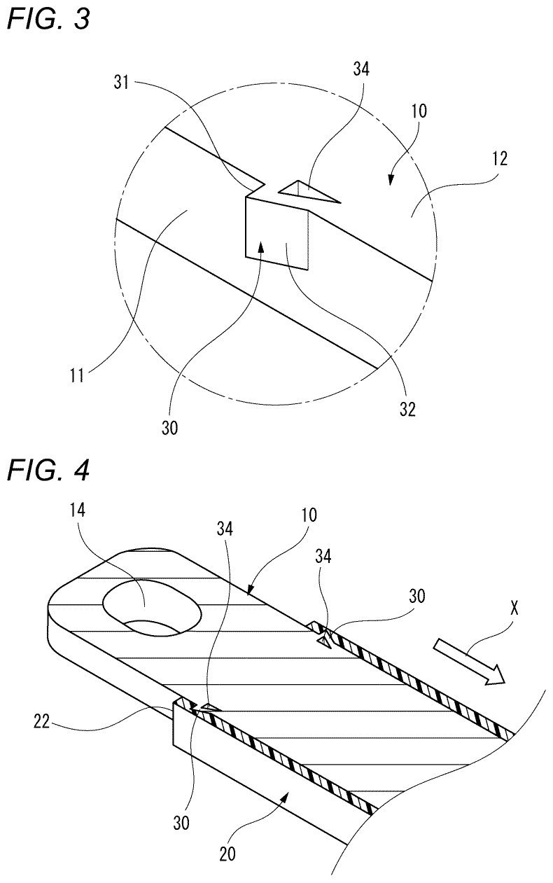

FIG. 1 is a perspective view of a resin tube 20 of the conductive member 1 according to the embodiment of the present disclosure illustrated in an imaginary line. FIG. 2 is an overall perspective view of a flat conductor 10 illustrated in FIG. 1. FIG. 3 is an enlarged view of a portion A in FIG. 2. In the present embodiment, upper-lower, front-rear, and left-right directions in the conductive member 1 follow upper-lower, front-rear, and left-right directions indicated by arrows in FIG. 1.

As illustrated in FIG. 1, the conductive member 1 according to the present embodiment mainly includes the strip-shaped flat conductor (busbar) 10 and the resin tube 20 installed to cover a periphery of an intermediate portion of the flat conductor 10.

As illustrated in FIG. 2, the flat conductor 10 according to the present embodiment is formed of a conductive metal plate having a substantially elongated flat plate shape and pressed into a prescribed shape, and is formed with a connection hole 14 that vertically (plate thickness direction) penetrates each of two end portions in a longitudinal direction.

Various conductive metal materials such as copper, a copper alloy, aluminum, and an aluminum alloy can be used for the conductive metal plate.

The flat conductor 10 covered by the installed resin tube 20 is integrally formed with, on each of two side faces 11 in the left-right direction, which are surfaces thereof, locking protrusions 30 that catch an inner peripheral surface of the resin tube 20. The locking protrusions 30 are disposed in a vicinity of two end portions 22 of the resin tube 20.

As illustrated in FIG. 3, each of the locking protrusions 30 is a protrusion having a wedge-shaped cross section and a barb shape including a vertical surface 31 perpendicular to the side face 11 of the flat conductor 10 and an inclined surface 32 inclined relative to the side face 11.

That is, as illustrated in FIG. 4, the locking protrusion 30 having a barb shape is formed such that a locking force for preventing the end portion 22 of the resin tube 20 from moving in a direction away (rightward direction in the drawing) from the adjacent end portion of the flat conductor 10 in the longitudinal direction is larger than a locking force for preventing the end portion 22 from moving in a direction toward (leftward direction in the drawing) the adjacent end portion of the flat conductor 10 in the longitudinal direction.

The locking protrusion 30 can be easily formed by, for example, punching an upper face 12 of the flat conductor 10 in a vicinity of the side face 11 to expand the side face 11 in a left-right width direction. A triangular recess 34 in the upper face 12 is a punch hole formed by punching. It is needless to say that a method for forming the locking protrusion 30 is not limited thereto, and various known methods can be used.

The resin tube 20 according to the present embodiment is a heat shrinkable tube having at least one of electrical insulation and heat resistance. Therefore, inserting the flat conductor 10 into the resin tube 20 having a prescribed length and heating and heat-shrinking the resin tube 20 can easily form an insulation film that covers a part of an outer periphery of the flat conductor 10.

Whether the resin tube 20 has one or both of the electrical insulation and the heat resistance is appropriately selected depending on a use place or a use purpose of the conductive member 1.

When the resin tube 20 heat-shrinks, as illustrated in FIG. 4, the locking protrusion 30 integrally formed on each of the two side faces 11 of the flat conductor 10 bites into and catches the inner peripheral surface of the resin tube 20 installed to cover a periphery of the flat conductor 10. Therefore, positional deviation of the resin tube 20 relative to the flat conductor 10 in the longitudinal direction is prevented.

Particularly, the locking protrusion 30 having the above-described barb shape has a large locking force for preventing the end portion 22 of the resin tube 20 from moving in a direction away from the adjacent end portion of the flat conductor 10 in the longitudinal direction.

Therefore, when the flat conductor 10 is inserted into the resin tube 20, the insertion operation is facilitated. Then, when the resin tube 20 is heat-shrunk and installed to cover the periphery of the flat conductor 10, it is possible to prevent positional deviation of the resin tube 20 in the direction (direction of the arrow X) away from the adjacent end portion of the flat conductor 10 in the longitudinal direction, ensure insulation from other components, and prevent electric shock due to touch.

Next, a conductive member 1A according to a modification will be described.

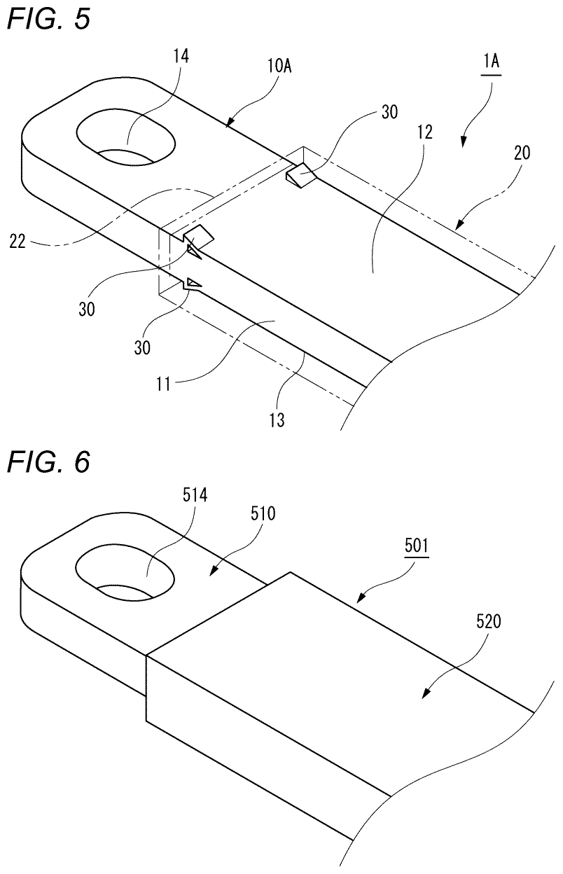

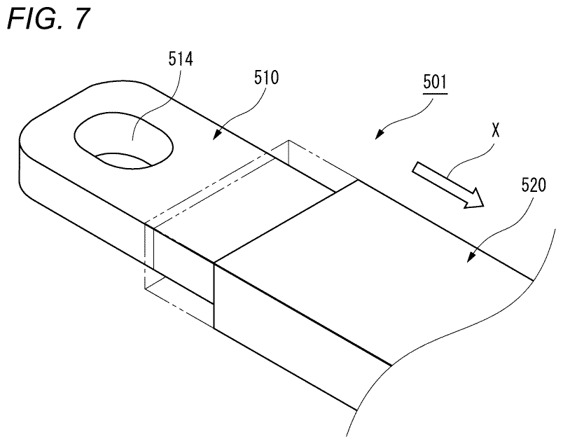

FIG. 5 is a perspective view illustrating a part of the resin tube 20 of the conductive member 1A according to the modification illustrated in an imaginary line. Components of the conductive member 1A similar to those of the conductive member 1 in the above embodiment are denoted by the same reference numerals, and detailed description thereof will be omitted.

As illustrated in FIG. 5, the conductive member 1A according to the modification mainly includes a strip-shaped flat conductor 10A and the resin tube 20 installed to cover a periphery of an intermediate portion of the flat conductor 10A.

Similar to the flat conductor 10 in the above embodiment, the flat conductor 10A according to the modification is formed of a conductive metal plate having a substantially elongated flat plate shape and pressed into a prescribed shape, and is formed with the connection hole 14 that vertically penetrates each of two end portions in the longitudinal direction.

The flat conductor 10A covered by the installed resin tube 20 is integrally formed with, on each of the upper face 12 and a lower face 13 which are surfaces thereof in the upper-lower direction, a pair of locking protrusions 30 that catch the inner peripheral surface of the resin tube 20. The locking protrusions 30 are disposed in a vicinity of the end portions 22 of the resin tube 20.

That is, the locking protrusions 30 of the flat conductor 10A can be easily formed by punching the two side faces 11 of the flat conductor 10A in a vicinity of the upper face 12 and the lower face 13 to push the upper face 12 and the lower face 13 in the upper-lower direction.

Similar to the locking protrusions 30 of the flat conductor 10, each of the locking protrusions 30 of the flat conductor 10A is also formed in a barb shape in which a locking force for preventing the end portion 22 of the resin tube 20 from moving in a direction away (rightward direction in the drawing) from the adjacent end portion 22 of the resin tube 20 in the longitudinal direction is larger than a locking force for preventing the end portion 22 from moving in a direction toward (leftward direction in the drawing) the adjacent end portion of the flat conductor 10A in the longitudinal direction.

Then, it is possible to obtain the conductive member 1A in which an insulation film that covers a part of an outer periphery of the flat conductor 10A is easily formed by inserting the flat conductor 10A into the resin tube 20 having a prescribed length and heating and heat-shrinking the resin tube 20.

When the resin tube 20 heat-shrinks, the locking protrusions 30 integrally formed on the upper face 12 and the lower face 13 of the flat conductor 10A bite into and catch the inner peripheral surface of the resin tube 20. Therefore, it is possible to prevent positional deviation of the resin tube 20 in the longitudinal direction relative to the flat conductor 10A, ensure insulation from other components, and prevent electric shock due to touch.

Further, in the conductive member 1A, integrally forming the locking protrusions 30 on the upper face 12 and the lower face 13 of the flat conductor 10A that have a relatively larger area than the side faces 11 can increase the number of the locking protrusions 30 and enhance a locking force to the resin tube 20.

Therefore, according to the conductive members 1, 1A in the present embodiment described above, it is possible to prevent positional deviation of the resin tube 20 relative to the flat conductors 10, 10A.

The present disclosure is not limited to the embodiment described above, and can be appropriately modified, improved, and the like. In addition, materials, shapes, sizes, numbers, arrangement positions, and the like of components in the embodiment described above are freely selected and are not limited as long as the present disclosure can be implemented.

For example, the above embodiment described an example using the resin tube 20 formed of a heat shrinkable tube. Alternatively, the resin tube of the present disclosure is not limited to a heat shrinkable tube, and various resin tubes can be used as long as the resin tube can be installed to cover a periphery of a flat conductor.

Here, features of the conductive member of the present disclosure described above will be briefly summarized and listed in [1] to [3] below. [1] A conductive member (1, 1A) includes:
a strip-shaped flat conductor (10, 10A);
a resin tube (20) installed to cover a periphery of the flat conductor (10, 10A); and
a locking protrusion (30) integrally formed on a surface (side face 11, upper face 12, and lower face 13) of the flat conductor (10, 10A) and configured to catch an inner peripheral surface of the installed resin tube (20).

According to the conductive member (1, 1A) described in [1], the locking protrusion (30) integrally formed on the surface (side face 11, upper face 12, and lower face 13) of the flat conductor (10, 10A) bites and catches the inner peripheral surface of the resin tube (20) installed to cover the periphery of the flat conductor (10). Therefore, positional deviation of the resin tube (20) relative to the flat conductor (10, 10A) in the longitudinal direction is prevented.
[2] In the conductive member (1, 1A) according to [1], the locking protrusion (30) has such a barb shape that a locking force for preventing an end portion (22) of the resin tube (20) from moving in a direction away from an adjacent end portion of the flat conductor (10, 10A) in a longitudinal direction is larger than a locking force for preventing the end portion (22) from moving in a direction toward the adjacent end portion of the flat conductor in the longitudinal direction.

According to the conductive member (1, 1A) described in [2], when the flat conductor (10, 10A) is inserted into the resin tube (20), the insertion work is facilitated. Then, when the resin tube (20) is installed to cover the periphery of the flat conductor (10, 10A), it is possible to prevent positional deviation of the resin tube (20) in a direction away from the adjacent end portion of the flat conductor (10, 10A) in the longitudinal direction, ensure insulation from other components, and prevent electric shock due to touch.
[3] In the conductive member (1, 1A) according to [1] or [2], the resin tube (20) is a heat shrinkable tube having at least one of electrical insulation and heat resistance.

According to the conductive member (1, 1A) described in [3], inserting the flat conductor (10, 10A) into the resin tube (20) having a prescribed length and heating and heat-shrinking the resin tube (20) can easily form an insulation film that covers a part of the outer periphery of the flat conductor (10, 10A).

What is claimed is:

1. A conductive member comprising:
a strip-shaped flat conductor;
a resin tube installed to cover a periphery of the flat conductor; and
a locking protrusion integrally formed on a surface of the flat conductor and configured to catch an inner peripheral surface of the installed resin tube.

2. The conductive member according to claim 1,
wherein the locking protrusion has such a barb shape that a locking force for preventing an end portion of the resin tube from moving in a direction away from an adjacent end portion of the flat conductor in a longitudinal direction is larger than a locking force for preventing the end portion of the resin tube from moving in a direction toward the adjacent end portion of the flat conductor in the longitudinal direction.

3. The conductive member according to claim 1,
wherein the resin tube is a heat shrinkable tube having at least one of electrical insulation and heat resistance.

4. The conductive member according to claim 2,
wherein the resin tube is a heat shrinkable tube having at least one of electrical insulation and heat resistance.
